(19) United States
(12) Patent Application Publication
(10) Pub. No.: US 2010/0162869 A1
(43) Pub. Date: Jul. 1, 2010

(54) Mandoline having adjustable infeed and outfeed decks

(76) Inventors: Richard S. Smith, Hot Springs, AR (US); Louis Chalfant, Hot Springs, AR (US)

Correspondence Address: EDWARD D. GILHOOLY, 28 E. JACKSON BLVD., SUITE 423, CHICAGO, IL, 60604, US

(21) Appl. No.: 12/653,729

(22) Filed: Dec. 18, 2009

Related U.S. Application Data
(60) Provisional application No. 61/203,665, filed on Dec. 29, 2008.

(51) Int. Cl. B26D 1/02; B26D 7/06

(52) U.S. Cl. 83/707; 83/856; 83/438; 83/440.2; 83/932

(57) ABSTRACT

A mandoline for cutting and/or slicing food items having an infeed deck and outfeed deck pivotally mounted on a housing adjacent each other in a sloped longitudinal orientation. Adjacent end portions of the infeed deck and outfeed deck are vertically spaced. The end portion of said outfeed deck includes a fixed blade mounted above the end portion of said infeed deck. A pair of knob assemblies are rotatably mounted on opposite sides of the housing and each include a pair of open cam slots and respectively engage a pin respectively formed on opposite sides of said infeed deck and said outfeed deck. Rotation of said cam assemblies causes said infeed deck and outfeed deck to move simultaneously either toward or away from each other to vary the space between the fixed blade and said infeed deck.

This application claims priority to provisional application, Ser. No. 61/203,665 filed Dec. 29, 2008.

### BACKGROUND OF THE INVENTION

1. Field of the Invention

This invention relates to food cutters and more particularly, to an improved mandoline for slicing and cutting cooked and raw food items and the like.

2. Summary of the Prior Art

A mandoline is a known kitchen utensil having a fixed blade for slicing and cutting raw and cooked food items in various shapes, thicknesses and forms, dependent on such variables as the type of cutting blade and the separation of the cutting edge of the cutting blade from the surface of a feed deck. A mandoline generally includes an infeed deck having a surface spaced from an outfeed deck having the cutting blade. In the prior art, several techniques are employed to vary the spacing between the item feeding surface and the blade edge to control the thickness of the cut. A mandoline is a preferred culinary tool among professional chefs. Using various blade attachments, a mandoline is capable of slicing, making julienne cuts, waffle cuts, crinkle cuts and the like. A food item is usually slid along an infeed surface and an outfeed surface, usually by a manual food pusher, between which a fixed blade is mounted for cutting and slicing. One of the advantages of mandolines is derived from its ability to produce uniform slices, an important result in the preparation of many foods, for example, that are deep fried or baked, or just for presentation. An example of a food item in which a uniform thickness is particularly desirable is in the preparation of potato chips.

In a mandoline, it is important to maintain parallelism between the infeed surfaces and outfeed surfaces between which cuts or slices made. In the prior art an optimum technique for maintaining parallelism for effective food preparation with safety of use has not been attained with a relatively economical and effective system and method. Accordingly, it is desirable in the prior art to provide an improved mandoline apparatus that produces accurate uniform cuts or slices on a rigidly safe support table.

### SUMMARY OF THE INVENTION

It is therefore an objective of the invention to provide an improved apparatus for slicing and cutting items, such as a mandoline as described herein. The mandoline of the invention includes a downward sloped infeed deck having an adjustable upper slotted surface upon which food items can be slid into contacting relationship with a cutting blade. An outfeed deck supporting the cutting blade is also simultaneously adjustable with the infeed deck to provide adjustment of the relative separation of the surface of the infeed deck and cutting blade to adjust for thickness of the items being sliced or cut. The adjustment assembly herein produces foregoing simultaneous movement of both the infeed deck and outfeed deck in equal increments whereby parallelism between the respective decks is maintained in all adjusted positions. The infeed deck and outfeed deck include pins adjacent the cutting station that extend in respective cam slots formed on rotatable knob assemblies. Movement of the pins relative to cam slots cause both decks to be simultaneously moved in equal increments upward or downward to control thickness of the cuts. The adjustable mounting of the infeed and outfeed decks as described herein provides an effectively rigid structure in all conditions of use for safety and efficiency. The operating efficiency of the mandoline herein attains superior precise results comparable to more expensive complex designs in the prior art.

### BRIEF DESCRIPTION OF THE DRAWINGS

FIG. 1 is a top perspective view of mandoline of the invention;

FIG. 2 is a top plan view of the mandoline of FIG. 1;

FIG. 3 is a bottom view of the mandoline of FIG. 1;

FIG. 4 is a rear elevational view from the outfeed end of the mandoline of FIG. 1

FIG. 5 is a rear elevational view from the infeed end of the mandoline of FIG. 1;

FIG. 6 is a partial side perspective view of the cam knob assembly of the mandoline of FIG. 1;

FIG. 7 is a side elevational view of the cam knob assembly of the FIG. 6;

FIG. 8 is a side elevational view, with the opposite side being mirror image of the side as shown, of the mandoline of FIG. 1;

FIG. 9 is a top perspective view the infeed deck of the mandoline of FIG. 1; and

FIG. 10 is a top perspective view the outfeed deck of the mandoline of FIG. 1.

### DESCRIPTION OF THE PREFERRED EMBODIMENT

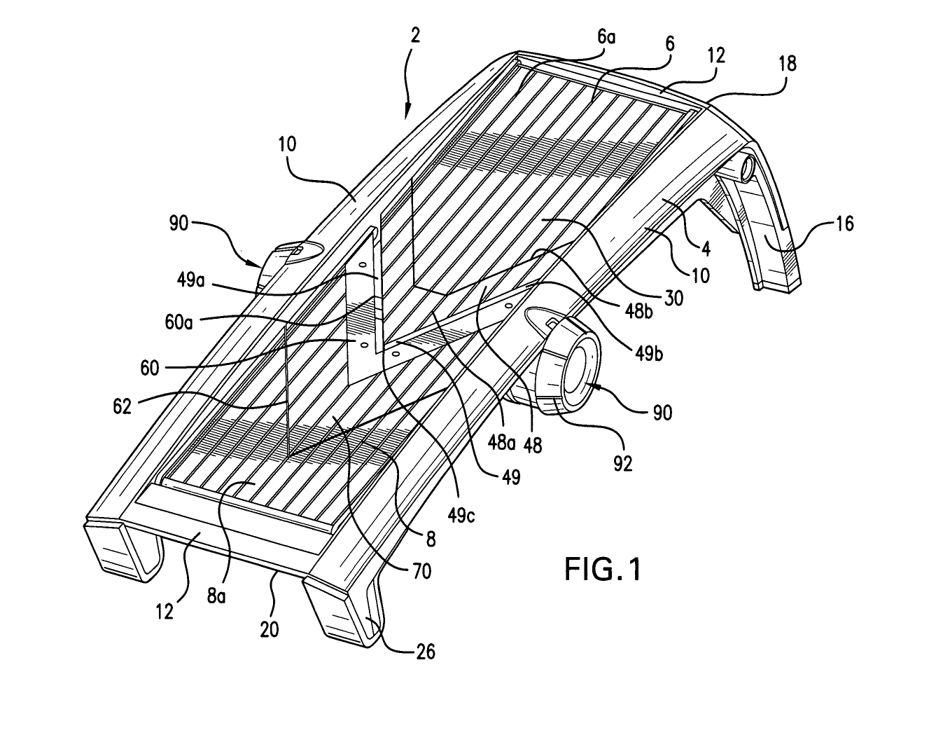

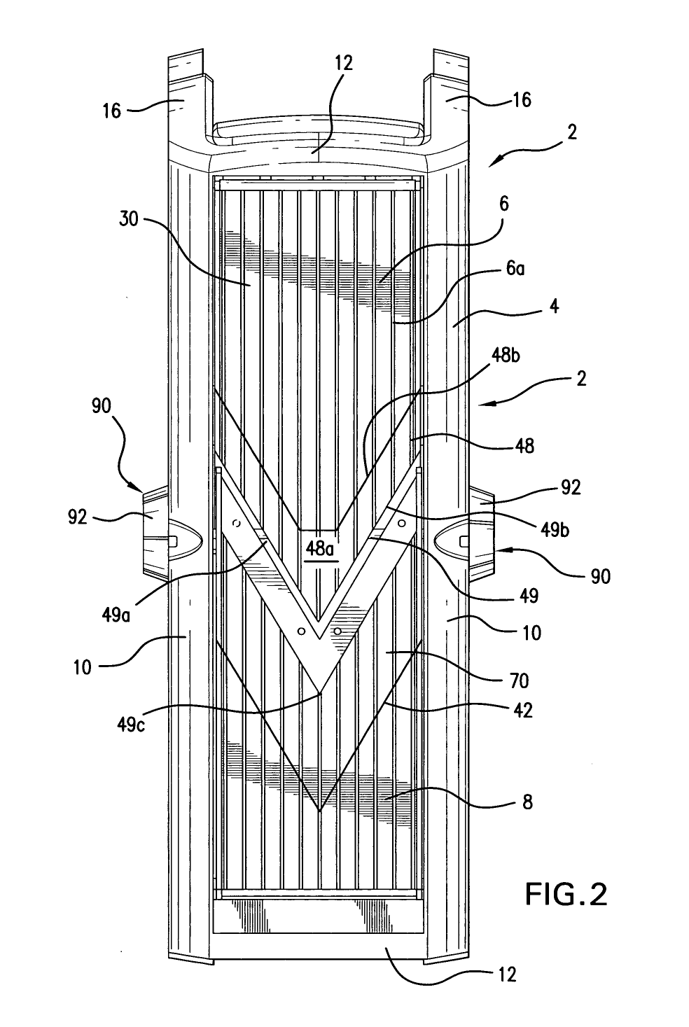

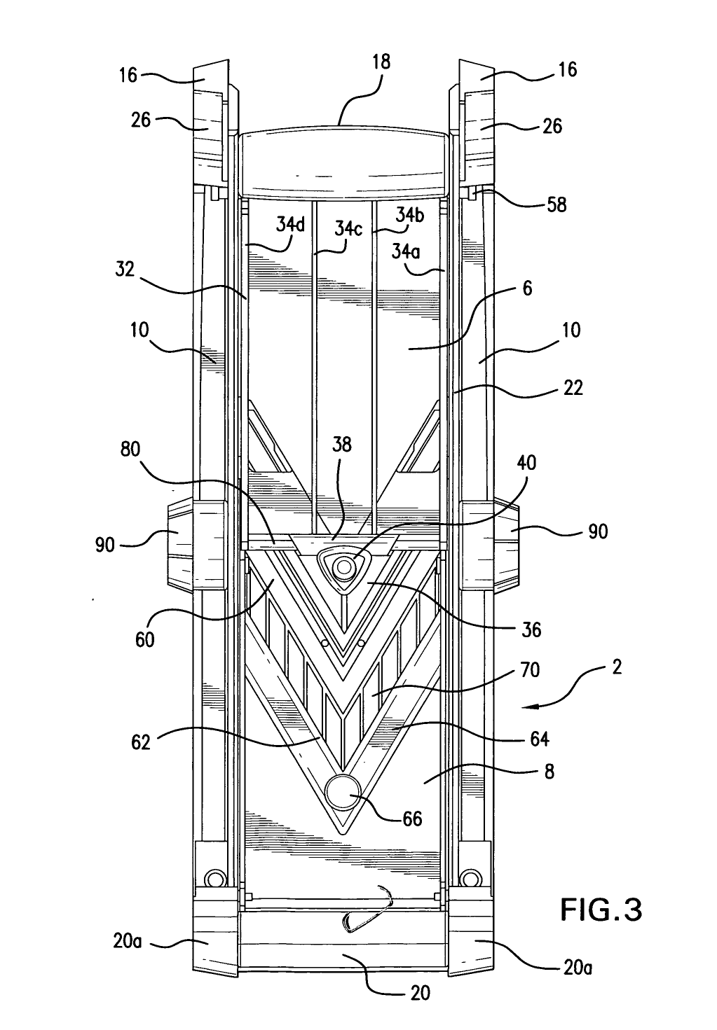

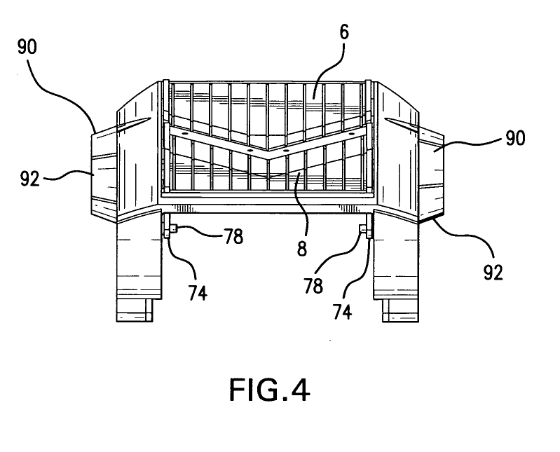

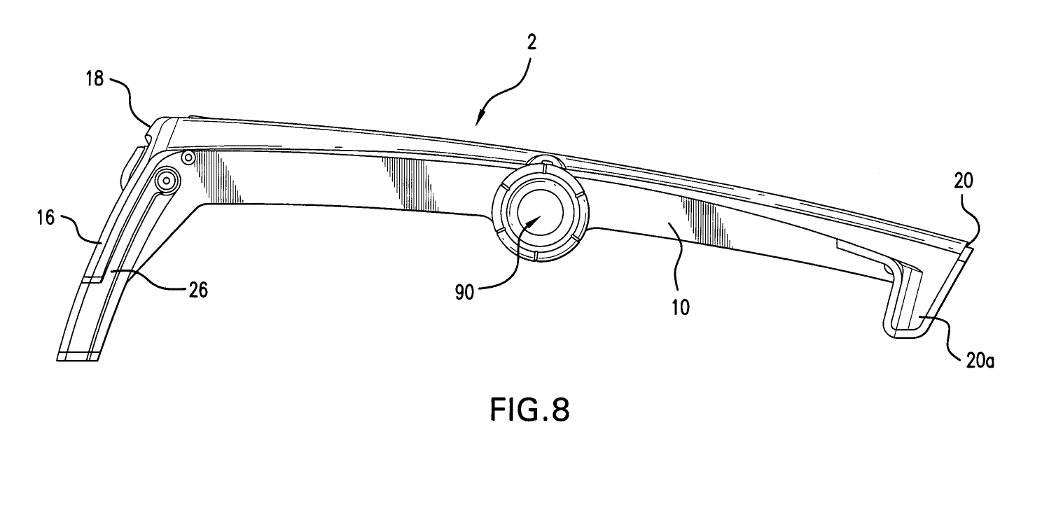

Referring now to FIGS. 1-10, there is illustrated the mandoline of the invention, generally designated by reference numeral 2. As best seen in FIGS. 1-5 and 8, the mandoline 2 is provided with frame 4, formed from a metal or plastic, upon which an adjustable infeed deck 6 and outfeed deck 8 are mounted in a sloped manner in adjacent longitudinal relationship. The adjustable infeed deck 6 includes a slotted upper surface 6a and the outfeed deck has slotted upper surface 8a. The frame 4 composes parallel longitudinal beams 10 having a generally U-shaped lateral cross section, integral to opposite connecting end portions 12. A pair of legs 16 are integral to frame 4 at feed end 18 which end is raised in comparison to lower outfeed end 20 so as to create sloped upper surfaces to move fed food items downward in use. As seen in FIG. 3 the beams 10 include inner vertical walls 22. Adjacent upper end 18 of frame 4, a pair of lower supports 26 having elongated vertical portions are suitable mounted on legs 16, which legs may be alternatively adjustable or fixed as desired. At end 20 lower support member 20a supports the lower end on a support surface (not shown) as best seen in FIG. 8.

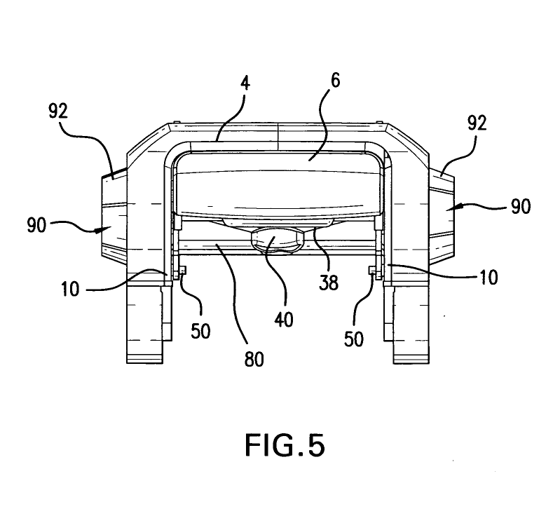

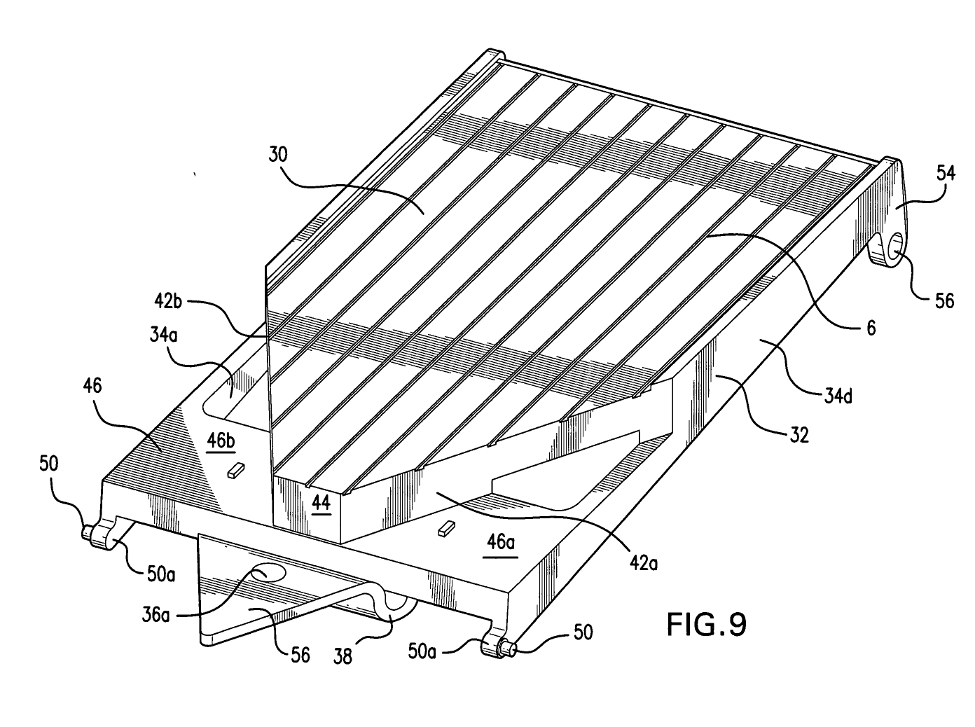

Referring now to FIGS. 1, 2, 3, and 9, details of infeed deck 6 is shown. Infeed deck 6 includes a generally rectangular upper plate 30 integrally reinforced by a lower frame 32 having four flat vertically arranged support members 34a,b,c,and d (FIG. 3). As seen in FIG. 3, the frame 32 has a triangularly shaped inward end section 36 integrally affixed to a member having upwardly open U-shaped section 38. The end section 36 possesses a threaded hole 36a (FIG. 9) through which a lower knob 40 (FIG. 3) having a upwardly extending threaded shaft portion extends. The upper portion of infeed deck 6 is cut to form a pair of angular edges 42a, b interconnected by a lateral flat edge 44. In FIG. 9, a flat horizontal plate 46 having upper surfaces 46a,46b is provided on the frame 32 further supports vertical support members 34a, b and 34c, d. A removable upper infeed extension 48 (FIGS. 1, 2, and 3) is mounted beneath outfeed deck 8 on flat plate 46 to form an upper surface 48a lying in the same plane surface as surface 6a. The extension 48 includes a rear edge portion 48b corresponding in shape to the cut end of infeed deck 6 to create a continuous feeding surface, whereby the removable upper infeed extension end plate 46 is secured by suitable retention means on surfaces 46a, 46b. The edge portion 49 adjacent the outfeed deck 8 comprises a pair of intersecting edges 49a, b to create pointed end 49c, such that the edge portion 49 is longitudinally spaced beneath outfeed deck 8. As shown in FIGS. 5 and 9, a pair of opposed pins 50 are carried by projecting structure 50a respectively connected to frame support members 34a and 34d. The upper end 18 of infeed deck 32 has a projection 54 having holes 56 to engage pins 58 (FIG. 3) projecting from the inner surface of main frame beams 10, 10a to create a pivotal mounting of the feed deck 6 adjacent upper end 18.

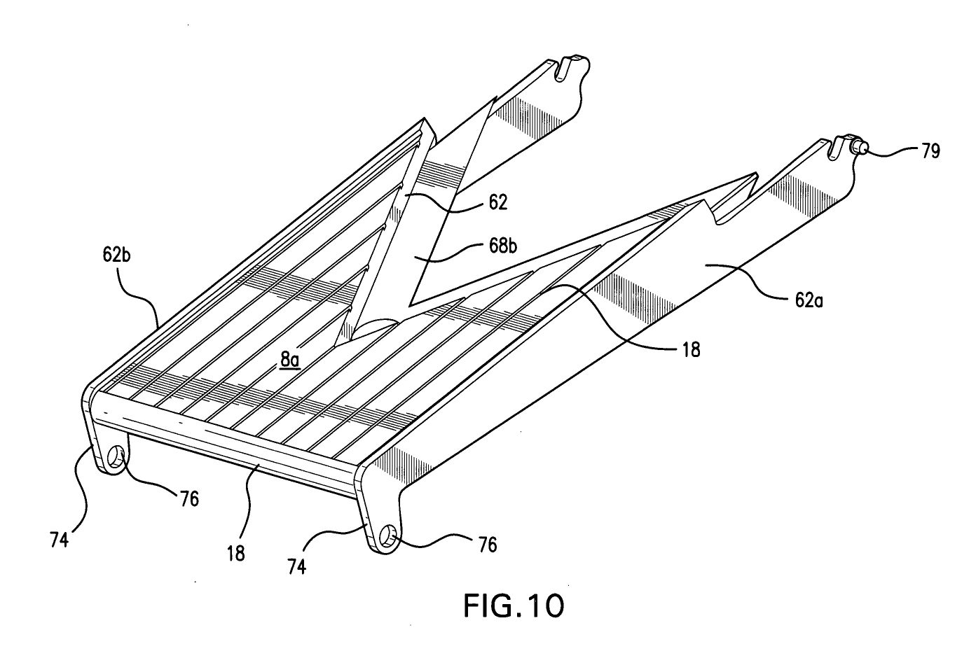

Referring to FIGS. 1, 2, 3, and 10 details of the outfeed deck 8 are illustrated. The outfeed deck 8 removably mounts a V-shaped metal cutting blade 60 having cutting edge 60a which is vertically adjustable in relative infeed deck 6. Although a V-shaped blade is shown, it is within the scope of the invention to employ blades not having a V-shaped configuration, such as having straight or curved leading blade edges. Further, although the V-shaped cutting blade 60 has a pair of straight cutting blade edges 60a as shown, other blades as commonly used with V-shaped mandolines, such as, for example, perpendicular blades for cutting strips, julienne blades, serrated edges, and the like, may be used interchangeable with blade 60. The foregoing other blades may also be suitably mounted on the infeed deck(not shown) in conjunction with straight blade edges 60a, if desired. As seen in FIGS. 1, 2, 3, 4, and 10 the outfeed deck 8 generally comprises a rectangular member having an upper V-shaped leading edge 62 forming an end portion disposed above the infeed deck 6. The V-shaped edge 60 is reinforced by a raised portion 64 through which a knob 66 having an upwardly extending threaded shaft (not shown). The foregoing threaded shaft which is connected to rotatably mounted knob 66 engages a threaded hole in a removable V-shaped insertion member 70 mounted against edge 62 on a lower flat surface 68b of outfeed deck 8. The ends of V-shaped blade 60 are removably mounted on the V-shaped insertion 70 in horizontal slots (not shown) whereby the upper surface 60b of blade 60 and upper surface 70a are coplanar with surface 8a of outfeed deck 8. The side walls 62a, b of outfeed deck 8 extend beyond upper surface 8a and include projections 74 having respective holes 76. Pins 78 extend from vertical beams 22 to pivotally mount the outfeed deck 8 at its lower end 20. In FIG. 10, opposed pins 79 are included at the opposite ends of the sides 62a,62b. From the foregoing it should be apparent that items being cut are moved along the infeed deck 6 to engage cutting blade 60 for cutting and slicing. The separated segment of the item being cut is thereafter collected. The item being cut may be moved multiple times on the mandoline surface until the desired number of cuts or slices is collected.

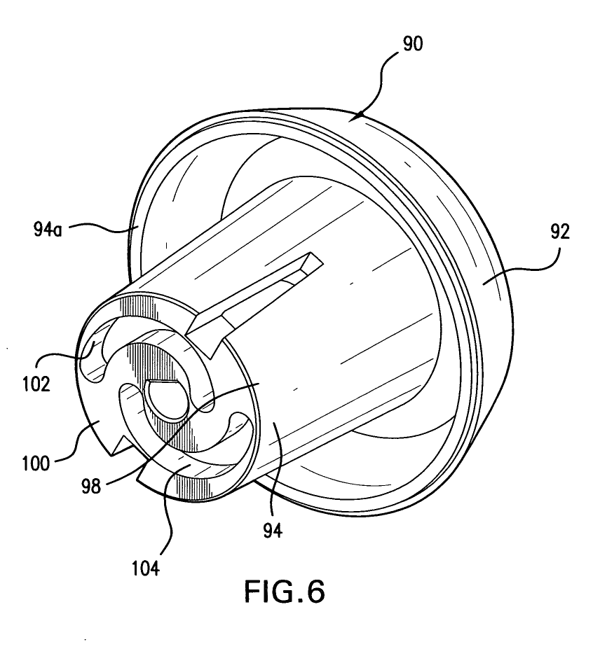

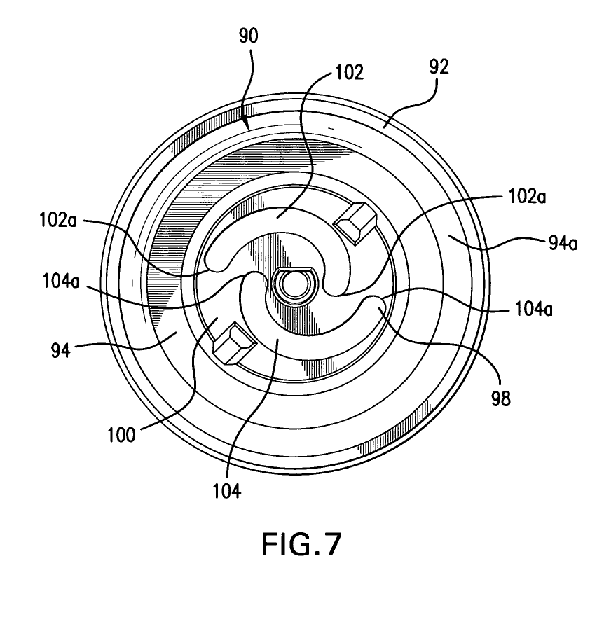

Referring to FIG. 3, a lateral shaft 80 extends between holes (not shown) in opposite beams 10 at a generally intermediate longitudinal position of the beams. The shaft 80 is rotatably supported intermediately by U-shaped section 38 and above by the extension 48. A knob assembly 90 is suitably affixed to the opposite ends of shaft 80 and forms a cam assembly as will be described. As seen in FIGS. 1-5, 7, and 8, the knob assembly 90 is manually rotated by opposite outer rotatable knobs 92. In FIGS. 6 and 7, details of the inner portion 94 of knob assembly 90 are best shown. The inner portion 94 of knob assembly 90 includes hollow sleeve 94a in which an integral hub 98 projects respectively adjacent the lower end and the upper end of infeed deck 6 and outfeed deck 8. The end face 100 of each of the hubs 98 on each side of the mandoline 2 are formed with a pair of open eccentric cam slots 102 and 104 which are closed at opposite ends. The slots 102 are disposed on a respective knob face 100 vertically above slots 104. Slots 102 respectively receive opposed pins 79 (FIG. 10) of the outfeed deck 8. The slots 104 receive pins 50 (FIG. 9) of the infeed deck 6. As described previously, the infeed deck 6 and outfeed deck 8 are pivotally mounted adjacent ends 18 and 20 by pins 58 and 78.

The eccentric curvature of each of slots 102 and 104 is designed to move the adjacent decks 6 and 8 simultaneously toward and away from each other in equal increments dependent on the direction of rotation of the knob assemblies 90 to reduce or increase the separation and hence thickness of a cut by varying the distance of spacing between the edge of cutting blade 60 above the feed surface 48a of extension 48 mounted on the infeed deck 6. Although slots 102 and 104 are shown with a particular curvilinear shape, it is within the scope of the invention top to use other slot designs with or without eccentric cam followers. Parallelism between the infeed deck 6 and out feed deck 8 is maintained in all adjusted positions of separation. The closed ends 102a and 104a establish a stop for pins 79 and 50 in slots 102 and 104 at which position the blade 60 is positioned beneath the infeed deck 6 to provide a safety function when the mandoline 2 is not is use. A maximum separation cutting is established when pins 79 and 50 are respectively in contact with opposite closed ends 102b and 104b. It should be apparent that multitude of other separations can be made through adjustment of the knob assembly 90 dependent on the respective positions of the pins 79 and 48 relative to the slots 102 and 104. Rotation of one of the knob assemblies 90 will simultaneously rotate the opposite knob assembly. As a result of the designs of the infeed deck 6 and outfeed deck 8 in conjunction with their interaction with eccentric cam slots 102 and 104, rotational forces are negated after adjustment by knobs assemblies 90 in a manner that the pins 79 and 50 are maintain a stationary position in slots 102 and 104 in all adjusted positions between the infeed deck and the outfeed deck so that the infeed deck 6 and outfeed deck 108 assume a relative secured position as selected during use of the mandoline 2. By situating the infeed deck and outfeed deck stationary with respect to each other in all adjustment positions, no mechanical lock is needed to secure cut thickness. Such equilibrium is attained during use without external locks since the mandoline 2 is designed without a moment arm, but it is further within the scope of the invention to employ other force considerations to achieve this function, including the location of the cam pins. For safety a food pusher or steel gloves (not shown) are normally used to push the food items down the sloped upper surfaces of the mandoline 2.

What is claimed is:

1. A mandoline comprising
a housing having an infeed deck and outfeed deck being longitudinally arranged with respect to each other and having respective adjacent end portions being disposed in separated relationship,
said infeed deck and said outfeed deck being mounted on said housing for a range of adjustments by varying the distance of separation between the end portion of said infeed deck and the end portion of said outfeed deck,
at least one cam assembly operatively connected to said infeed deck and said outfeed deck to selectively vary said distance of separation through simultaneous movement of said infeed deck and said out feed deck, and
a cutting blade affixed to said outfeed deck to form said end portion of said outfeed deck.

2. The mandoline according to claim 1 wherein said infeed deck and said outfeed deck are respectively mounted in pivotal relationship respect to said housing adjacent opposite end from said end portions.

3. The mandoline according to claim 1 wherein said cutting blade has a V-shaped leading edge.

4. The mandoline according to claim 3 wherein said blade is removeably mounted.

5. The mandoline according to claim 1 wherein said at least one cam assembly simultaneously moves said infeed deck and said outfeed deck in equal increments toward and away from each other to vary said distance of separation.

6. The mandoline according to claim 5 wherein said at least one cam assembly maintains parallelism of said infeed deck and said outfeed deck in all positions of said range of adjustments.

7. The mandoline according to claim 6 wherein said connection of said at least cam assembly maintains said selected distance of separation between said infeed deck relative to said outfeed in all positions of said range of adjustments.

8. The mandoline according to claim 7 wherein said at least one cam assembly is rotatably mounted on said housing.

9. The mandoline according to claim 8 wherein said at least one cam assembly includes first and second cam elements operatively connected to said infeed deck and said outfeed deck.

10. The mandoline according to claim 9 wherein said first cam element includes a first curved open slot operatively connected to said infeed deck and a second open curved slot operatively connected to said second deck.

11. The mandoline according to claim 10 wherein said first and second slots being mounted on at least one knob assembly.

12. The mandoline according to claim 11 wherein said infeed deck and outfeed deck each have cam elements for engaging said first and second open slots.

13. The mandoline according to claim 12 wherein said at least one cam assembly comprises a pair of cam assemblies rotatable mounted on opposite sides of said housing.

14. The mandoline according to claim 13 wherein said pair of cam assemblies comprise a pair of knob assemblies mounted on said opposite sides of said housing.

15. The mandoline according to claim 1 wherein said infeed deck is further moveable to a position above said blade during non-use for safety protection.

16. An apparatus to cut and slice items comprising
a housing having an infeed deck and an outfeed deck having a fixed blade mounted above an end of said infeed deck,
said infeed deck and said outfeed deck each having cam projections and being mounted on said housing for selective movement to adjust the distance between said blade and said end portion of said infeed deck for selecting a thickness of cut,
at least one knob assembly rotatably mounted on said housing for varying said distance between said fixed blade and said end portion, and
said at least one knob assembly having a pair of cam elements for engaging said cam projections of said infeed deck and said outfeed deck for simultaneously moving said infeed deck and said outfeed deck to adjust said distance.

17. The apparatus according to claim 16 wherein said cam elements are a pair of open curved slots.

18. The apparatus according to claim 16 wherein said at least one knob assembly comprises a pair of knob assemblies mounted on opposite sides of said housing and each pair of knob assemblies having a pair of said open curved slots, said infeed deck and said outfeed decks each having a cam projection adjacent said pair of knob assemblies for engaging a respective one of said curved open slots.

19. The apparatus according to claim 16 wherein said infeed deck is further moveable by said at least one knob assembly to a position above said blade during non-use for safety.

20. The apparatus according to claim 16 wherein said at least one knob assembly is secured against movement in all distances of adjustment of said blade relative to said infeed deck.
